(19) United States
(12) Patent Application Publication
(10) Pub. No.: US 2010/0193996 A1
(43) Pub. Date: Aug. 5, 2010

(54) METHOD OF CASTING AND DEVICES THEREFORE.

(76) Inventor: Dmitry Sergeevich Platonov, Moscow (RU)

Correspondence Address: SERGEY PLATONOV, 16-7 LOMONOSOVA STR. PO Box#341, ZHUKOVSKY-1, MOSCOW REG., MOSCOW, 140181, RU

(21) Appl. No.: 12/671,206

(22) PCT Filed: Dec. 3, 2008
(86) PCT No.: PCT/RU08/00649

§ 371 Date: Apr. 22, 2010

(30) Foreign Application Priority Data
Oct. 19, 2007 (RU) 2007138721

(51) Int. Cl. B29C 39/38; B29C 39/36; B28B 7/00

(52) U.S. Cl. 264/319; 264/334; 249/175; 249/184

(57) ABSTRACT

Method of casting, comprising the following steps: obtaining a casting substance, submersing of mould parts into said casting substance, filling the said mould with casting substance by joining said parts thereof, retrieving said mould filled with casting substance in joint state, cooling the mould and extracting the cast from the mould. All parts of the mould are fully submersed in a container with the casting substance. All parts of the mould are connected within the submersed position. Connected mould is retrieved from the container with the casting substance. Casting device, realizing said method, comprising container with casting substance, mould comprising of one or more parts, submersing means, parts joining means, retrieving means. Container with casting substance adapted for full submersion and retrieving parts of the mould in connected and disconnected states. Casting device may be realized as conveyor line.

### PRIOR ART

The disclosed invention relates generally to methods of casting and particularly to methods and devices of casting in mould.

Many casting methods and devices are known in the art.

[1], [2], [3] and [4] give the spread overview of a plurality of old and new casting methods and theories thereof.

Known methods of casting have various shortcomings and limitations, for example, limitations on castability of casting substances, etc. Obtaining casting pieces of jumbo size is also a rather difficult problem.

A particular of known casting methods closely alike the proposed invention is casting by squeezing. Casting by squeezing is one of the versions of casting in chill mould. It is used to obtain large-sized panel type casts (up to 2500×1400 mm) with wall thickness of 2-3 mm. According to this casting method metallic half-moulds are fastened in the specialized casting squeezing machines with one- or two-sided movable (turning) mould halves (with one or two movable half-moulds).

The main distinctive feature (the main feature) of this casting method comprises in forced filling of mould halves cavities by a flow of fusion (melting substance) during the relative approach of mould halves (during half moulds approaching (getting connected)). Hardening of casting material initially in the place of contact with the surface of mould halves during their filling is a strong requirement for the casting operation (process). No elements of usual pouring gating system are present in the mentioned casting mould. Excess casting material is evacuated flowing over the mould edge. This method is used for producing preferably aluminum alloys castings, which have narrow solidification temperature range. The rate of fusion uplifting in the mould cavity working area is very critical for the mentioned method. Essential reference: according to the process requirements for casting of aluminum alloys panels the mentioned rate is be in the range of 0.5-0.7 m/s. Lower speed causes not proper filling of thin castings areas, extra high speed causes the hydrodynamic defects: waviness, roughness of casting surface, capture of air bulbs, erosion of sandy pivots and formation of break of flow cracks etc. Metal is poured into preheated containers. In a contact zone of connected surfaces a defective area of casting (blisters, friability) appears. The fusion cooling speed is strictly controlled by coating of mould cavity working surface with heat-insulating coverage of various thicknesses. Overheat of alloys before pouring should not exceed 15-20° above liquidus temperature. The mould halves approach time is normally 3-5 sec.

Main advantages of method of the present invention lies in a possibility of application thereof to large-sized thin-walled castings (with sizes of 1.0×2.5 m and wall thickness of 1.5-5.0 mm) and in the full absence of pouring gate system.

The main shortcomings are:

strong process discipline required,

a plurality of critical parameters and close limits of parameters for successful processing,

lower preciseness of casting dimensions (in comparison with casting in metal moulds) and a high percentage of spoilage (50-75%),

complexity of casting moulds manufacturing,

need for specialized machines for casting by squeezing, each to be made under special order,

high restrictions on casting material liquid fluidity,

invariable presence of casting defective area with blisters and friability in a connected surfaces contact zone,

low process productivity.

The method of casting by squeezing and device are taken as a prior art.

### SUMMARY OF THE INVENTION

The proposed invention deals with method and device providing to obtain the following technical results (advantages):

better filling of casting substance with low fluidity within the mould,

increase of process productivity,

the process is more simple, requiring practically no special work tools,

even casting cooling,

decrease of hydraulic resistance in the mould cavity and obtaining possibility of filling thereof at temperature within the interval of crystallization.

In accordance with declared technical result, the method of casting comprises following steps:
preparation of casting substance (obtaining it in liquid or close to liquid form),
pouring of casting substance into container,
total submersion of mould parts into container with casting substance,.
joining (connection) of mould parts,
retrieval of joined (connected) mould from container with casting substance,
hardening of casting in the mould,
detaching (disconnection) of mould parts,
taking out the casting.

Dimension and shape of the container inlet (filled with the casting material) must allow free submersion (introduction) and retrieving of the mould in joined and detached positions. After the introduction of mould all its cavities and parts are filled with the casting material with no additional efforts. Usually it happens immediately if casting substance is not too strong. The parts of mould are adapted to be reliably connected. To improve the filling of the mould cavities its parts should have cylindrical mating junction surfaces to obtain extra internal pressure at the moment of mould connection. The pouring gate system is provided in the problem mould to force out gases and/or extra casting substance. Parts of the mould may have couplings for better fastening.

The essence of the proposed method is represented in FIG.1-2.

The essence of the proposed device is represented in FIG. 3-4.

### DESCRIPTION OF THE DRAWINGS

FIG. 1 is a diagram of the declared casting process.

FIG. 2 is a diagram of the possible versions of the mould parts.

FIG. 3 is a diagram of the possible version of the declared casting method.

FIG. 4 is a diagram of the declared casting process, using the one part mould.

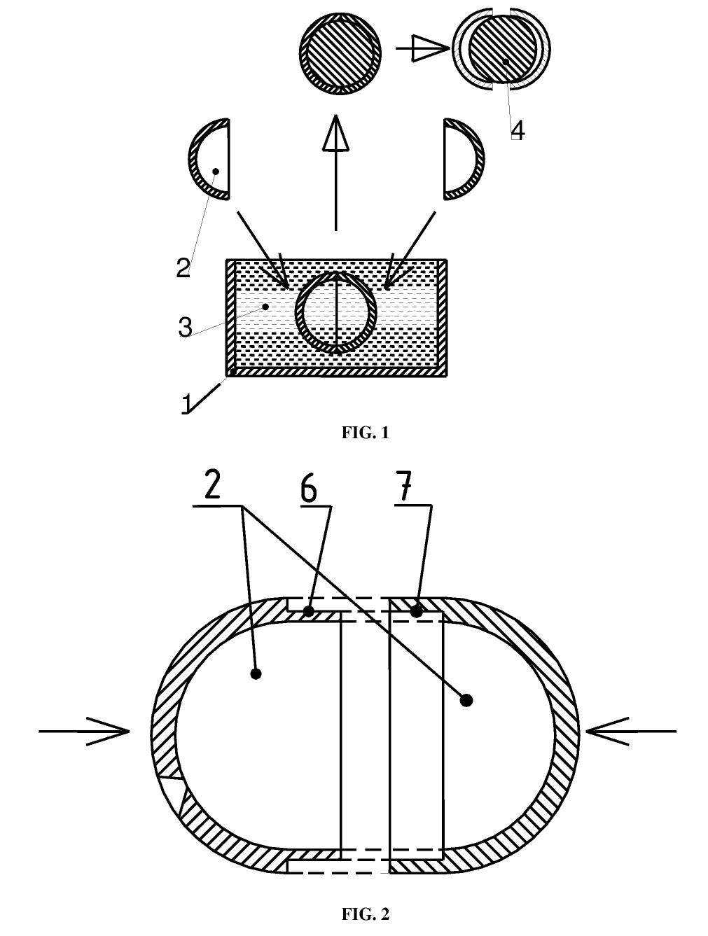

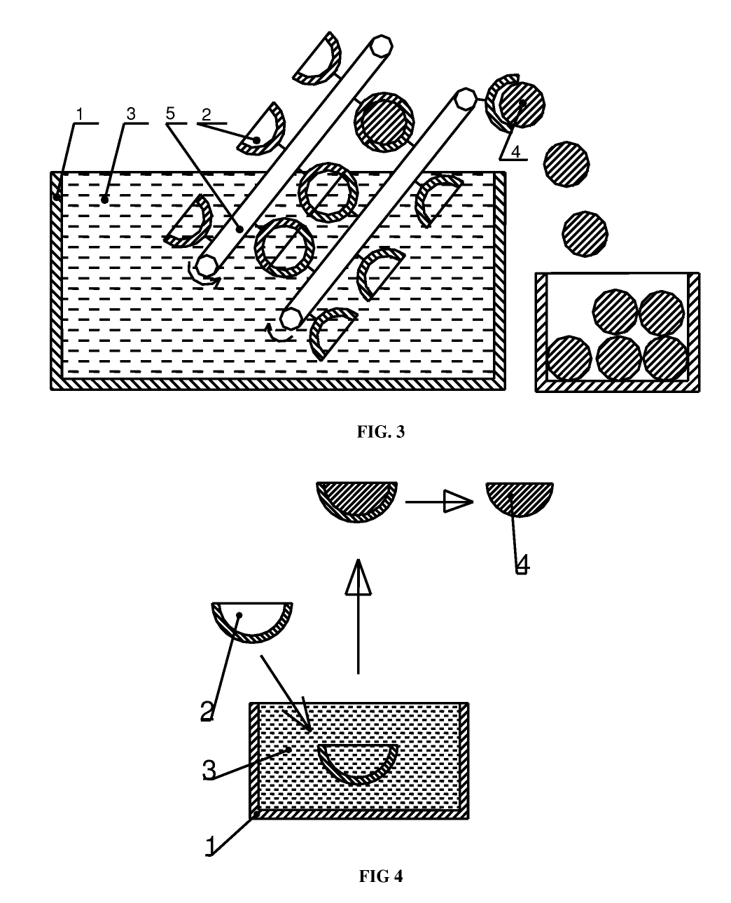

### DETAILED DESCRIPTION

The main point of the proposed invention as method of casting comprises the following.

Two or more parts 2 of the mould are completely introduced into container 1 with liquid casting substance 3) with the aid of introduction means. All parts of the mould are joined (connected) in the submerged position with the aid of parts connecting means of the mould. Then the mould is retrieved with the aid of mould retrieving means. After that the mould is cooled. After cooling, the cast 4 is extracted from the mould. Means for the parts of the mould submersion, means for the parts of the mould junction (connection) in submersed position and means for the mould retrieving can be combined in a single device. Container dimensions and shape must allow free submersion of the mould parts and retrieving of the mould in joint position.

In the embodiment when the mould consists of one part, the casting process comprises the following. The one-part-mould is completely submersed in the container 1 with casting substance 3 with the aid of submersing means in the very orientation for better filling thereof. The mould is then oriented open side up (to escape the casting substance losing), retrieved with the aid of mould retrieving means. Then the mould is subjected cooling. The finished product (cast) is extracted from the mould. The means for submersion of the mould parts and the mould retrieving means can be combined in a single device. Container must allow free submersion and retirement of the mould.

The mould may comprise the only part. Then the casting method will be the following. The mould must have inlet dimensions sufficient filling thereof.

The method of casting in this case includes following steps:

submersing of mould into container with casting substance;

complete filling of mould with casting substance;

taking the mould out open side up to escape losing the casting substance;

cooling the mould;

extracting the casting from the mould.

If the injection casting material (casting substance) is loose or granular material particles thereof are concatenated by sintering at high temperature. After retrieving the mould from container with the material (casting substance) the mould is heated to sintering temperature to obtain the finished product.

The main point of the proposed invention as device for casting according to the proposed method comprises the following devices, items and parts.

One or more parts of the mould are subjected pre-heating.

Mould parts are connected with the force sufficient to keep them connected, until the complete hardening of casting material.

One or more parts of said mould are made compound.

One or more parts of said mould produces a locally heightened internal pressure of casting material during the assembling thereof.

The proposed technical solution as a device for obtaining articles by the declared method consists of the following devices:

container with casting substance,

two or more parts of the mould,

submersing means for submersing parts of the mould into container with casting substance,

joining means for joining parts of the mould in the submersed position,

retrieving means for retrieving the mould from container with casting substance.

Parts of the mould are submersed into container with casting substance until complete submersion with the aid of submersing device. Parts of the mould are completely filled with the casting material. Parts of the mould are joined together (connected) in the submersed position by mould parts joining means. Mould in the joint position is retrieved by the mould retrieving means. Filled mould is subjected cooling and extracted from the mould cavity.

Device realizing above said methods can be a conveyor line. Conveyor line is the dual (triple or multiple) conveyor, with a single or more parts of mould on each line. The dual (triple or multiple) conveyor line contains area where mould is submersed, area where the mould is retrieved from casting substance, area where the filled mould is being cooled and area, where finished cast is extracted from the mould. In the submersing area parts of the mould are joined together until full connection thereof. Parts of the mould are joined by the mould parts joining device. Casting can be subjected self cooling during the conveyor line motion after retrieving the filled mould from container with the casting substance or with the aid of special device, which maintains the special regime of casting hardening. In the area of casting extracting parts of the mould are disconnected and casting is extracted. Casting may be extracted with the aid of extraction device.

In another preferred embodiment where conveyor line is single line, the mould, (including the one fixed on the conveyor), is completely submersed in casting substance.

In one more preferred embodiment where conveyor consists of two or more lines, lines are laid so as in some area the mould parts are to be joined together. Parts of the mould fixed on and moved with conveyor lines, are completely submersed into casting substance. Parts of the mould in submersed position are interconnected and then retrieved from casting substance in the connected state. Further the cast is being cooled, parts of the mould are disconnected and cast is extracted. Parts of the mould 2 are submersed into container 1 with casting substance 3. Parts 2 of the mould are connected and then retrieved from container 1 in connected state. Then the mould is being cooled and the cast 4 is taken out of the mould. When connected, mating cylindrical parts 6 and 7 of the mould 2 allow to obtain enhanced pressure for better filling of the mould.

Device for obtaining casts by the declared method consists of:

container 1 with casting substance 3;

two or more parts 2 of mould;

submersing means for complete submersing parts of the mould;

joining means for joining parts of the mould in submersed position;

retrieving means for retrieving the mould.

Submersing means, joining means, and also retrieving means can be realized as united single device.

Another preferred embodiment of device can be conveyor line 5.

The device consists of dual, triple or multiple conveyor line 5, if the mould consists of two, three or more parts. Each part of the mould 2 may be fixed on one conveyor line 5. Conveyor line 5 is so arranged that a part of a route lies close to container 1 with casting substance 3 and in the course of movement the mould is subjected submersing into the casting substance 3, other part of a route lies so as to retrieve the cast from the container to provide cooling (or hardening) conditions. A particular means for cast hardening may be situated in this part of the route.

Method of casting for the case of the conveyor line is the following.

In the course of conveyor line 5 motion with parts of the mould 2 fixed thereon, parts of the mould are on the first step subjected submersing into casting substance 3 in container 1. Then parts of the mould 2 are joined together within the container 1. In the course of the conveyor line further movement the mould in joint state is retrieved from the container 1 and then subjected cooling with or without the aid of supplementary cooling means. Then parts of the mould are disconnected and finished cast is extracted from the mould with or without aid of supplementary extracting means.

### REFERENCES CITED

1. CASTING ALLOYS AND FOLDING METHODS THEREFORE IN MASCHINERY. M. MASCHINERY. 1984.

2. Folding methods theory. L/: MASCHINERY. 1976.

3. V. P. PERMONOV, V. A. NERONOV “materials science and technology of materials”, Part 3. “Cast forming theory and practice” UDK 669.017 CYBERIA State GEODESIC ACADEMY (CSGA), 2006, V. P. PERMONOV, V. A. NERONOV, 153 pages, ill.

4. http://hghltd.yandex.com/yandbtm?url=http%3A%2F%2Fwww.ssga. ru%2FAllMetodMaterial%2Fmetod_mat_for_ioot%2Fmetodichki%2Fpermi nov%2Fg181.html&text=EB%E8%F2%FC%E5%20%E2%FB%E6%E8% EC%E0%ED%E8%E5%EC&reqtext=(%EB%E8%F2%FC%E5%3A%3A199053%20%26%26%20%E2%FB%E 6%E8%EC%E0%ED%E8%E5%EC%3A%3A9615287)%2F%2F6&dsn=0&d=340874&sh=2&sg=10&isu=1

What I claim is:

1. Method of casting, comprising the following steps:
obtaining a casting substance;
submersing of mould parts into said casting substance;
filling the said mould with casting substance by joining said parts thereof;
retrieving said mould filled with casting substance in joint state;
cooling the mould and
extracting the cast from the mould,
said casting substance is prepared in quantity sufficient for the complete submersion of mould in separate and joint states;
said all parts of the mould are fully submersed in a container with the casting substance;
said all parts of the mould are connected within the submersed position;
said connected mould is retrieved from the container with the casting substance.

2. Method as recited in claim 1, wherein one or more parts of the mould are pre-heated.

3. Method as recited in claim 1, wherein the parts of the mould contain cylindrical mating surfaces at junction places, allowing to obtain heightened internal pressure when being connected.

4. Method as recited in claim 1, wherein the two or more parts of the mould are equipped with locks to prevent spontaneous detachment (separation).

5. Method as recited in claim 1, wherein said mould parts are connected with the force sufficient to keep them connected until the complete hardening of casting material.

6. Method as recited in claim 1, wherein one or more parts of said mould is made compound.

7. Method as recited in claim 1, wherein one or more parts of said mould produces a locally heightened internal pressure of casting material during the assembling thereof.

8. Method as recited in claim 1, wherein the casting substance is liquid.

9. Method as recited in claim 1, wherein the casting substance is powder.

10. Method as recited in claim 1, wherein the casting substance is granules.

11. Method of casting comprising
obtaining casting substance,
filling of one mould,
cooling the mould and
extracting casting from the mould,
said casting substance is prepared in a sufficient quantity for the complete submersion of mould;
said mould is completely submersed in container with the casting substance until the complete filling of said mould;
said cooling is performed with/without aid of supplementary means;
said casting is extracted from said mould with/without aid of supplementary means.

12. Casting device comprising
container with casting substance;
mould comprising of one or more parts;
means for submersing of mould parts;
means for mould joining parts in the submersed position;
means for retrieving the connected (joint) mould,
said container with casting substance adapted for full submersion and retrieving parts of the mould in connected (joint) and disconnected states;
said means for (joining) connecting parts of mould are adapted to (join) connect said parts in submersed position (when submersed);
said retrieving means is adapted for mould retrieving in connected (joint) state.

13. Casting device as recited in claim 12, wherein the means for submersion of mould parts, means for (connection) mould parts joining in submersed position and mould retrieving means are combined in one device.

14. Casting device comprising:
container with casting substance;
conveyor line with fixed mould parts thereon,
said conveyor line comprises a part of route where parts of mould are submersed into container with casting substance and are joined (connected) together in submersing position.

15. Casting device as recited in claim 14, wherein said conveyor line contains a part of the route for hardening the casting and extraction thereof.
